(19) United States
(12) Patent Application Publication
(10) Pub. No.: US 2026/0146856 A1
(43) Pub. Date: May 28, 2026

(54) VEHICULAR TRAVEL ROUTE DETERMINATION METHOD AND SYSTEM

(71) Applicant: RIDEFLAG TECHNOLOGIES INC., Mississauga (CA)

(72) Inventors: Michel Papineau, Osprey, FL (US); Mark Feltham, Mississauga (CA)

(73) Assignee: RIDEFLAG TECHNOLOGIES INC., Mississauga (CA)

(21) Appl. No.: 18/956,905

(22) Filed: Nov. 22, 2024

(51) Int. Cl. G01C 21/34; G07B 15/06

(52) U.S. Cl. CPC G01C 21/3461; G07B 15/06

(57) ABSTRACT

Vehicular travel route determination may be performed using a mobile device within the vehicle that is capable of performing geolocation. The mobile device geolocates the vehicle at a starting location using at least one wireless signal. After the vehicle travels to an ending location, the mobile device determines that, during the traveling, the vehicle traveled along the road by determining an expected travel route of the vehicle between the starting and ending locations without performing geolocation while traveling, and by determining that a travel threshold has been satisfied. Satisfying the threshold includes determining that the expected travel route intersects the road or a widened model of the road. A navigation service may be used to determine the expected travel route. Additionally or alternatively, a curve connecting the starting and ending locations may be the expected travel route.

### TECHNICAL FIELD

The present disclosure relates to methods, systems, and techniques for determining a vehicular travel route and, more particularly, for determining that a vehicle has traveled along a particular road even when geolocation is unavailable while traveling along that road.

### BACKGROUND

Lanes earmarked for high-occupancy vehicles, such as high-occupancy vehicles and high-occupancy toll lanes, are valuable tools to incentivize carpooling. These lanes can accordingly help reduce traffic-related problems such as congestion and pollution. One issue with deploying these lanes is ensuring they are used only by persons who are, in fact, entitled to use them in a manner that is technically scalable to a large number of drivers and reliable in the face of technical challenges, such as the potential loss of location services during driving.

### SUMMARY

According to a first aspect, there is provided a method for determining that a vehicle has traveled along a road, the method comprising: geolocating the vehicle using at least one wireless signal at a starting location; after traveling, using the vehicle, from the starting location to an ending location: geolocating the vehicle using the at least one wireless signal at the ending location; and determining that, during the traveling, the vehicle traveled along the road by: determining an expected travel route of the vehicle between the starting location and the ending location without using the at least one wireless signal to perform geolocation while traveling from the starting location to the ending location; and determining that a travel threshold has been satisfied, wherein satisfying the travel threshold comprises determining the expected travel route intersects the road or a widened model of the road.

The method may further comprise generating the widened model of the road, wherein: the widened model of the road is wider along at least a portion thereof than a corresponding portion of the road; and satisfying the travel threshold comprises determining the expected travel route intersects the widened model of the road.

Determining the expected travel route of the vehicle may comprise obtaining a navigation service route between the starting and ending locations from a navigation service; and satisfying the travel threshold may comprise determining the expected travel route intersects the road.

The ending location may correspond to a location on the road.

The ending location may correspond to a toll booth on the road.

The method may further comprise: displaying, on a graphical user interface, a prompt requesting entry of a number of riders in the vehicle; and determining a number of riders in the vehicle based on a response to the prompt.

Generating the widened model of the road may comprise positioning a plurality of shapes intermittently along a route corresponding to at least a portion of the road, wherein each of the plurality of identical shapes extends beyond sides of the route.

The shapes may be identical to each other.

The shapes may be circles centered along a midline of the route.

Successive ones of the shapes may overlap with each other.

The travel threshold may comprise the expected travel route intersecting at least two of the shapes.

Determining that the expected travel route intersects the widened model of the road may comprise determining that a curve connecting the starting and ending locations intersects the widened model of the road, wherein the portion of the widened model of the road that is intersected corresponds to an area outside the sides of the road.

In some aspects, only one of the starting and ending locations may be located in the area outside the sides of the road and within the widened model of the road. Alternatively, both of the starting and ending locations may be located in the area outside the sides of the road and within the widened model of the road, and also be on a same one of the sides of the road.

Determining that the expected travel route intersects the widened model of the road may comprise: determining that a linear connection between the starting and ending locations avoids the widened model of the road; obtaining a navigation service route between the starting and ending locations from a navigation service; determining that the navigation service route between the starting and ending locations intersects the road.

The at least one wireless signal may be unavailable during the traveling between the starting and ending locations while the vehicle is on the road.

The method may further comprising, after the traveling, determining that a portion of the expected travel route that overlaps with the road is at least one of a minimum distance long or that traveling between the starting and ending locations along the expected travel route requires at least a minimum time. The minimum distance may be 2 km, and the minimum time may be 3 minutes.

Determining the travel threshold is satisfied may further comprise, after the traveling, determining that the expected travel route is at least one of a minimum distance long or that traveling between the starting and ending locations along the expected travel route requires at least a minimum time. This minimum distance and/or time may be determined based on the entire length of the expected travel route; alternatively, the minimum distance and/or time may be determined based on the portion of the expected travel route that overlaps with the road/the widened model of the road.

The vehicle may be traveling from the starting location to the ending location as part of a trip taken by the vehicle, and the starting location may differ from a location corresponding to a beginning of the trip, and/or the ending location may differ from an end of the trip.

The road may comprise a high occupancy lane, and the method may further comprise: sending an outbound message that the vehicle traveled along the road with multiple persons therein to at least one server; and receiving, from the at least one server, an inbound message that the vehicle was eligible to perform the traveling using the high occupancy lane, wherein the ending location corresponds to a location on or neighboring the road, and wherein the outbound message is sent while the vehicle is at the ending location.

The curve may be a straight line connecting the starting and ending locations.

According to another aspect, there is provided a system for determining that a vehicle has traveled along a road, the system comprising an antenna for receiving at least one wireless signal; and a processing unit, communicatively coupled to the antenna, and configured to perform the aforedescribed method.

According to another aspect, there is provided at least one non-transitory computer readable medium having stored thereon computer program code that is executable by at least one processor and that, when executed by the at least one processor, causes the at least one processor to perform the aforedescribed method.

This summary does not necessarily describe the entire scope of all aspects. Other aspects, features and advantages will be apparent to those of ordinary skill in the art upon review of the following description of specific embodiments.

### BRIEF DESCRIPTION OF THE FIGURES

In the accompanying drawings, which illustrate one or more example embodiments:

FIG. 1 depicts a system for determining a vehicular travel route, according to an example embodiment.

FIG. 2 is a block diagram of a mobile device that forms part of the system for determining a vehicular travel route, according to an example embodiment.

FIG. 3 depicts a map with a road and example expected vehicular travel route highlighted thereon.

FIG. 4 depicts a map with a widened model of the road and various expected vehicular travel routes highlighted thereon, according to various example embodiments.

FIG. 5 depicts a map with a best vehicular travel route as generated by a navigation service, according to an example embodiment.

FIGS. 6 and 8 are a flowcharts, each depicting a method for determining a vehicular travel route, according to example embodiments.

FIGS. 7A and 7B depict flowcharts of optional operations that may be performed during the method for determining a vehicular travel route, according to example embodiments.

### DETAILED DESCRIPTION

High-occupancy vehicle (“HOV”) and high-occupancy toll (“HOT”) lanes are lanes on roads that are meant to encourage carpooling, and thereby decrease car emissions and/or reduce traffic. Generally speaking, HOV lanes are lanes for which only vehicles transporting a minimum plurality of riders (e.g., at least two) are permitted to use those lanes. Similarly, HOT lanes typically permit vehicles transporting a minimum plurality of riders to use those lanes without paying any surcharge or, if a vehicle is transporting fewer than the minimum plurality of riders, to permit that vehicle to use an HOT lane upon payment of a surcharge.

A system designed to determine whether a vehicle qualifies for travel using an HOV lane or an HOT lane (without paying any surcharge) accordingly typically determines at least that 1) the number of riders in the vehicle during a trip is at least the minimum plurality of riders; and 2) that the vehicle has in fact traveled in, or along a road with, a HOV/HOT lane while carrying those riders. This allows the system to determine that the vehicle is carrying the requisite number of riders while having easy access to the HOV/HOT lane. An example of such a system is described in United States patent publication no. 2021/0174387, the entirety of which is hereby incorporated by reference herein.

Determining that the vehicle has in fact traveled in, or along a road with, a HOV/HOT lane may be done using a geolocation service, such as a global navigation satellite system of which a popular example is the U.S. Global Positioning System (“GPS”). In the system described in U.S. 2021/0174387 for example, a camera on a device such as a mobile phone may be used to verify that a vehicle has the requisite number of riders, and the mobile device may also be used to perform geolocation using, for example, a GPS signal, to confirm that the mobile device is traveling along a road with an HOV/HOT lane while carrying those riders. This allows the system to determine that a vehicle is in a position to receive, and in fact qualifies to receive, the benefit of being permitted to travel in the HOV/HOT lane (and in the case of the HOT lane, without having to pay a surcharge).

One technical problem that such a system can encounter during use occurs if the system is unable to geolocate during the trip. For example, part of the trip may be along city streets in which buildings obstruct GPS signals. As another example, the software application being used to perform geolocation using a mobile device may be suspended or terminated by the mobile device's operating system so as to preserve system resources, such as compute cycles, memory, and/or battery power. This can prevent the mobile device from performing geolocation while on the road, thereby preventing the mobile device from determining that the vehicle is in a position to qualify to take an HOV/HOT lane. While such information could be provided manually by a user, that is cumbersome and is likely, at scale, to result in inaccurate data. Methods and systems for determining that the vehicle has traveled along a road with a HOV/HOT lane without the benefit of wireless signals, such as GPS signals, are accordingly desirable.

The present disclosure is accordingly directed at methods, systems, and techniques for determining that a vehicle has traveled along a road between starting and ending locations without using geolocation on the road while traveling. The road has a high-occupancy vehicle lane, such as an HOV/HOT lane, or a bus lane. Geolocation using at least one wireless signal, such as a signal from a global navigation satellite system, cellular towers, or WiFi™ signals, is used to geolocate the vehicle at the starting location and again at the ending location. In some embodiments, a widened model of the road is also generated, with the widened model of the road being wider along at least a portion thereof than the corresponding portion of the road. The geolocation may be performed using, and the widened model of the road may be generated using, a suitable computing device including a mobile device such as a smartphone.

The mobile device, or another suitable computing device, may then determine that, during the traveling, the vehicle traveled along the road by determining an expected travel route of the vehicle between the starting location and the ending location without performing geolocation, and also determine that a travel threshold has been satisfied, where satisfying the travel threshold comprises determining that the expected travel route intersects the road or a widened model of the road. In some embodiments, the expected travel route may be determined using a navigation service. Additionally or alternatively, where the widened model of the road is used, the mobile device may generate it using any one or more suitable methods. Determining whether the travel threshold is satisfied may be used when determining whether to automatically provide HOV/HOT lane access to the vehicle.

The vehicle may be traveling along the road as part of a trip, and the starting and ending locations may or may not correspond to the start and finish of the trip. For example, the vehicle may start a trip and have continuous GPS signal access until reaching the starting location, which precedes the vehicle driving on to the road; and the GPS signal may return after the vehicle exits the road, following which the vehicle continues to drive until the trip ends. In this example, the beginning of the trip precedes the starting location and the end of the trip follows the ending location, and the various embodiments herein may be used to determine whether the vehicle traveled on the road between the starting and ending locations.

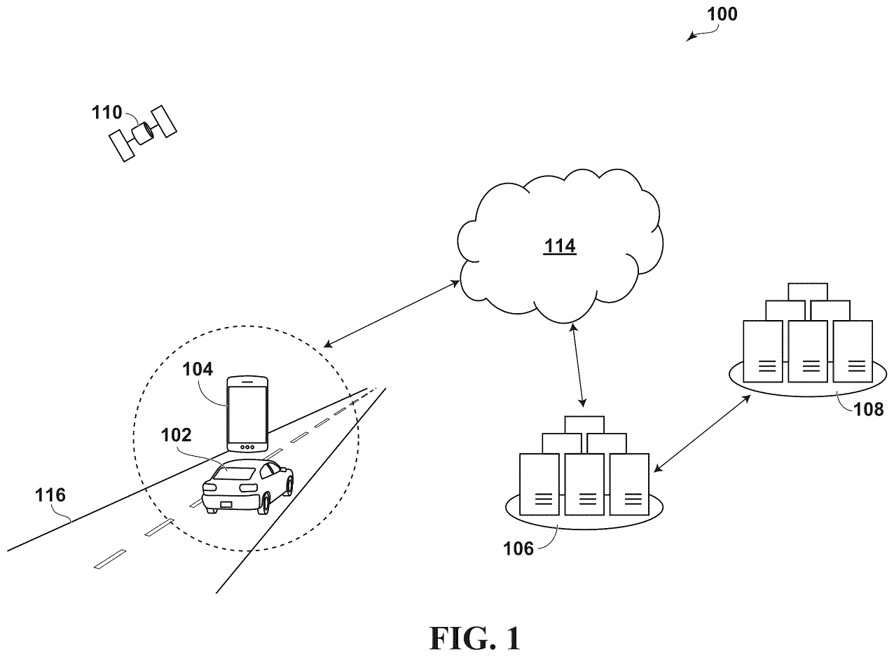

Referring now to FIG. 1, there is shown a system 100 for vehicular travel route determination, according to an example embodiment. The system comprises a vehicle 102, such as a car, that contains at least one rider (e.g., a driver and a passenger). At least one of the riders has a mobile device 104, such as a smartphone, that is able to receive at least one wireless signal such as a GPS signal from an overhead satellite 110. The mobile device 104 uses the wireless signal to geolocate itself at starting and ending locations (not shown in FIG. 1); however, while on the road, the mobile device 104 is unable to geolocate. As discussed above, this may be because the GPS signal is obstructed, or because the software application on the mobile device 104 performing the geolocation is terminated or suspended by the mobile device's 104 operating system.

The mobile device 104 is communicative with a wide area network 114, such as the Internet. Via the network 114, the mobile device 104 is able to communicate directly with a first group of servers 106 comprising at least one server that may be operated by a service provider that automatically determines HOV/HOT eligibility for vehicles. The first group of servers 106 is communicative with a second group of servers 108 comprising at least one server that may be operated by a transportation authority, for example, which has outsourced HOV/HOT eligibility to the service provider. The service provider accordingly manages communications with the mobile device 104 through the network 104 using the first group of servers 106 on behalf of the transportation authority, and sends a digest comprising a list of user accounts and HOV/HOT lane uses/authorizations to the second group of servers 108 and the transportation authority. In this way, the transportation authority obtains summary information and is able to audit the records of the service provider after-the-fact as desired.

While FIG. 1 shows the functionality performed by the first and second groups of servers 106, 108 being performed by two different groups of servers, in at least some other embodiments (not depicted) that functionality may be performed by a single group of servers comprising at least one server (e.g., where a transit authority itself is determining its own HOV/HOT eligibility, as opposed to outsourcing it to a service provider), or by more than two groups of servers (e.g., where the service provider itself subcontracts certain functionality to a third party).

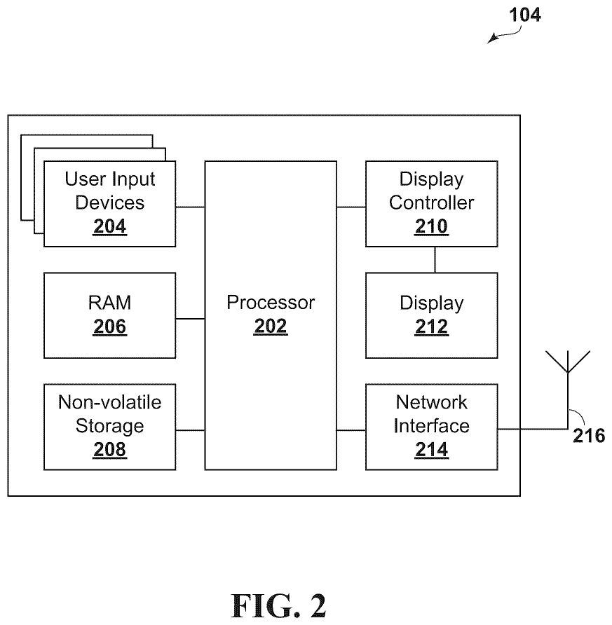

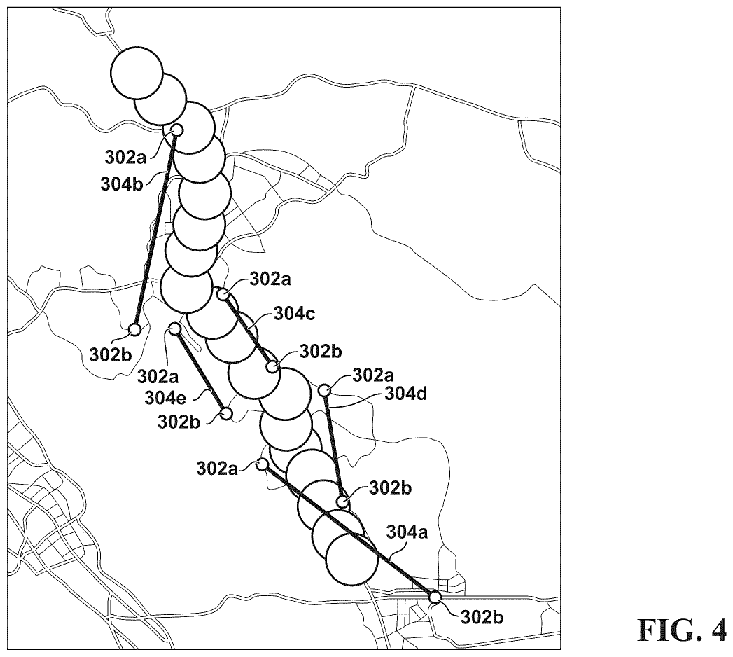

Referring now to FIG. 2, there is depicted a block diagram of the mobile device 104, according to an example embodiment. The mobile device 104 comprises a processor 202 that controls the overall operation of the device 104. The processor 202 is communicatively coupled to and controls several subsystems. These subsystems comprise user input devices 204, which may comprise, for example, any one or more of a touch screen and voice control; random access memory (“RAM”) 206, which stores computer program code for execution at runtime by the processor 202; non-volatile storage 208, which stores the computer program code executed by the processor 202 at runtime; a display controller 210 (which may include one or more graphical processing units), which is communicatively coupled to and controls a display 212; a network interface 214, which facilitates network communications with the wide area network 102; and an antenna 216, communicatively coupled to the network interface 214, to permit receipt of wireless signals used for geolocation such as GPS signals and to communicate with the network 114. The non-volatile storage 208 has stored on it computer program code that is loaded into the RAM 206 at runtime and that is executable by the processor 202. When the computer program code is executed by the processor 202, the processor 202 causes the mobile device 104 to perform the method for vehicular travel route determination, as described below in more detail with respect to FIGS. 4-6, 7A, 7B, and 8.

While the system depicted in FIG. 2 is described above specifically in respect of the mobile device 104, similar diagrams are applicable in at least some embodiments to each of the servers comprising the groups of servers 106, 108. For example, the user input devices 204 may comprise a keyboard and mouse, and the antenna 216 may be replaced with a physical port such as an Ethernet™ port.

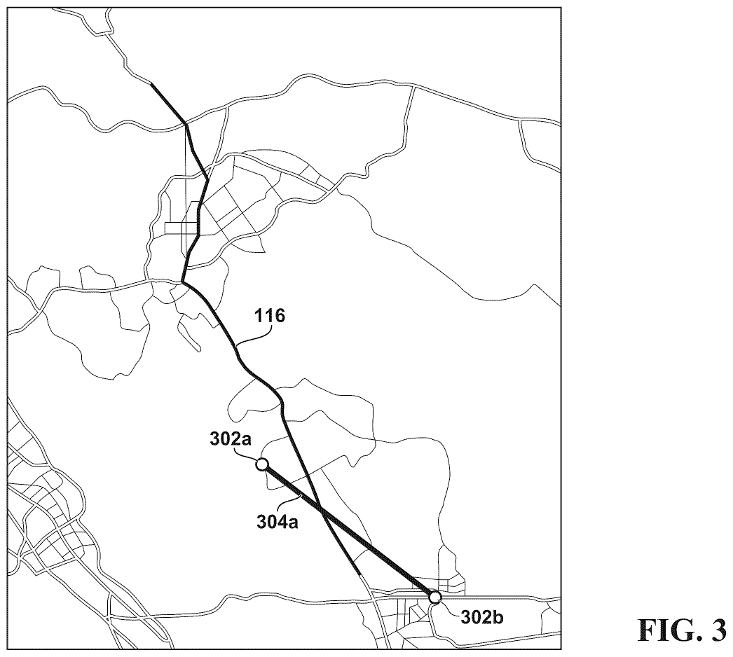

Referring now to FIG. 3, there is shown a map with a route corresponding to a road 116 (hereinafter simply the “road 116”) highlighted thereon. The road 116 has an HOV/HOT lane. The road 116 is shown unwidened in FIG. 3, in contrast to FIG. 4 as discussed below. In FIG. 3, the vehicle 102 starts a trip and, during the trip, loses the ability to perform GPS-based geolocation before driving on to the road 116. The ability to perform GPS-based geolocation returns after the vehicle 102 has exited off of the road 116. The location at which the vehicle 102 loses the ability to perform geolocation is the starting location 302a, and the location at which the vehicle 102 regains the ability to perform geolocation is the ending location 302b. As noted above, the starting and ending locations 302a,b may or may not correspond to the starting and ending locations of the entire trip the vehicle 102 took.

In this example, an example first expected travel route 304a is modeled as a straight line between the starting and ending locations 302a, and intersects the road 116. The intersection between the first expected travel route 304a and the road 116 is sufficient in this example to establish that the vehicle 102 traveled along the road 116 in order to travel between the starting and ending locations 302a,b. More particularly, in FIG. 3, the vehicle 102 traveled from the starting location 302a, via unmarked streets to the road 116, along the road southbound (i.e., downwards on FIG. 3) for a period of time, and then exits the road 116 and takes unmarked streets to arrive at the ending location 302b. Despite not having geolocation records for the period the vehicle 102 was actually on the road 116, by virtue of the first expected travel route 304a intersecting the road 116, the mobile device 104 or first group of servers 106 is able to conclude that the vehicle 102 traveled on the road 116 when traveling between the starting and ending locations 302a,b. Combined with concurrent validation that the vehicle contained the minimum plurality of riders during the trip, such as described in U.S. 2021/0174387 for example, the mobile device 104 and/or first group of servers 106 is able to confirm that the vehicle 102 was eligible to travel in the road's 116 HOV/HOT lane.

In certain situations, however, using an unwidened version of the road 116 will result in misclassification of trips as having avoided the road 116 when, in fact, the vehicle 102 traveled along the road 116. Examples of such trips are depicted in FIG. 4. FIG. 4 shows the first expected travel route 304a as discussed in respect of FIG. 3 above, and also second through fifth expected travel routes 304b-e each extending between their own respective starting and ending locations 302a,b. Unlike in FIG. 3, determining whether the vehicle 102 drove along the road 116 comprises determining whether the expected travel routes 304a-e intersect a widened model of the road 400 as opposed to the road 116 itself.

More particularly, the mobile device 104 generates a widened model of the road 400, and determines whether the vehicle 102 traveled along the road by determining whether the expected travel routes 304a-e intersect that widened model. In the depicted example embodiment, the mobile device 104 generates the widened model of the road 400 by positioning a plurality of circles 402 intermittently along the road 116, with each of the plurality of circles 402 extending beyond the sides of the road 116. The circles 402 in FIG. 4 are centered along a midline of the road 116, and successive circles 402 overlap with each other. The distance between the centers of successive circles 402 in FIG. 4 is 1 km, although in at least some other embodiments (not depicted) this distance may differ.

Variations to the embodiment of FIG. 4 are possible. For example, at least some other embodiments may vary from the embodiment of FIG. 4 in accordance with any one or more of the following:
(a) while circles are used as the shape to widen the road 116 in FIG. 4, alternative shapes (e.g., squares, ellipses) may be used;
(b) while the shapes used to widen the road in FIG. 4 are all identical, the shapes may differ from each other in type (e.g., a combination of circles and squares may be used) and/or size (e.g., different circles having different radii may be used);
(c) while the shapes used to widen the road 116 in FIG. 4 are all centered along the midline of the road 116, any one or more of the shapes may be offset from the road's 116 midline, thereby eccentrically widening the road 116;
(d) while successive shapes in FIG. 4 overlap each other, they may alternatively be spaced apart from each other such that at least some successive shapes do not overlap; or
(e) while the mobile device 104 is described as generating the widened model of the road 400 in FIG. 4, in at least some other examples another computing device, such as the first group of servers 106, may generate the widened model of the road 400.

Once the widened model of the road 400 has been generated, the mobile device 104 determines whether the expected travel routes 302a-e intersect it by determining that a curve connecting the respective starting and ending locations 304a,b for each of the routes 302a-e intersects a portion of the widened model of the road 400 that corresponds to an area outside the sides of the road 116. Using the first expected travel route 302a again as an example, as in FIG. 3, the first expected travel route 302a satisfies this test since the curve (for the expected travel routes 302a-e in FIG. 4, each curve is a straight line) intersects the circles 402 that are outside the periphery of the road 116 shown in FIG. 3. The first expected travel route 302a accordingly is an example of a route that would be deemed to correspond to the vehicle 102 having traveled along the road 116, regardless of whether the widened model of the road 400 is generated.

FIG. 4 also shows the second through fifth expected travel routes 302b-e. Unlike with the first expected travel route 302a, none of the second through fifth expected travel routes 302b-e would intersect with the unwidened version of the road 116 shown in FIG. 3. However, when used in conjunction with the widened version of the road 400 of FIG. 4:
(a) Second expected travel route 302b. The starting location 302a of the second expected travel route 304b is west (i.e., to the left) of the road 116, but within the widened model of the road 400 by virtue of falling within one of the circles 402. The ending location 302b of the second expected travel route 304b is well west of the road 116 and outside the circles 402. The expected travel route 304b in the form of a line connecting these starting and ending locations 302a,b accordingly intersects with the widened model of the road 400, and the vehicle 102 is deemed to have traveled along the road 116 between the starting and ending locations 302a,b. This corresponds, for example, to the vehicle 102 starting at the starting location 302a, traveling east (i.e., right) towards the road 116, then traveling south (i.e., down) along the road towards the ending location 302b, following which the vehicle 102 exits from the road 116 and takes other roads to arrive at the ending location 302b.
(b) Third expected travel route 302c. The starting location 302a of the third expected travel route 304c is east (i.e., to the right) of the road 116, but within the widened model of the road 400 by virtue of falling within one of the circles 402. The ending location 302b of the second expected travel route 304b is similarly east (i.e., to the right of) the road 116, and also within the widened model of the road 400 by virtue of falling within another of the circles 402. The expected travel route 304c in the form of a line connecting these starting and ending locations 302a,b accordingly intersects with, and in fact is entirely contained within, the widened model of the road 400, and the vehicle 102 is deemed to have traveled along the road 116 between the starting and ending locations 302a,b. This corresponds, for example, to the vehicle 102 starting at the starting location 302a, traveling west (i.e., left) towards the road 116, then traveling south (i.e., down) along the road towards the ending location 302b, following which the vehicle 102 exits from the road 116 and takes other roads to arrive at the ending location 302b.
(c) Fourth expected travel route 302d. The starting location 302a of the fourth expected travel route 304d is well east (i.e., to the right) of the road 116 and outside the circles 402 and consequently outside the widened model of the road 400. The ending location 302b of the fourth expected travel route 304d is slightly east (i.e., to the right) of the road 116, but within the widened model of the road 400 by virtue of falling within one of the circles 402. The expected travel route 304d in the form of a line connecting these starting and ending locations 302a,b accordingly intersects with the widened model of the road 400, and the vehicle 102 is deemed to have traveled along the road 116 between the starting and ending locations 302a,b. This corresponds, for example, to the vehicle 102 starting at the starting location 302a, traveling west (i.e., left) towards the road 116, then traveling south (i.e., down) along the road towards the ending location 302b, following which the vehicle 102 exits from the road 116 and takes other roads to arrive at the ending location 302b.
(d) Fifth expected travel route 302e. The starting and ending locations 302a,b of the fifth expected travel route 302e are both well west (i.e., to the left) of the road 116 such that both are outside the widened model of the road 400. The curve connecting those starting and ending locations 302a,b is a straight line that is also entirely outside the widened model of the road 400. Consequently, the expected travel route 302e does not intersect the widened model of the road 400, and the vehicle 102 is deemed not to have traveled between the starting and ending locations 302a,b via the road 116.

The various examples shown in FIG. 4 accordingly include scenarios in which only one of the starting and ending locations 302a,b is located in the area outside the sides of the road 116 and within the widened model of the road 400 (the second and fourth expected travel routes 304b,d), and in which both of the starting and ending locations 302a,b are located in the area outside the sides of the road 116 and within the widened model of the road 400, and are also on a same one of the sides of the road 116 (the third expected travel route 304c). For these expected travel routes 304b-d, using the widened model of the road 400 allows the mobile device 104 to determine that the road 116 was used for travel despite the lack of geolocation services.

Additionally, while the curves connecting the starting and ending locations 302a,b in FIG. 4 are all straight lines, in at least some other embodiments any one or more of the curves may be non-linear (e.g., sinusoidal or another periodic function, or discontinuous). In certain embodiments, such as for the fourth expected travel route 304d, a non-linear curve connecting the starting and ending locations 302a,b may intersect the widened model of the road 400.

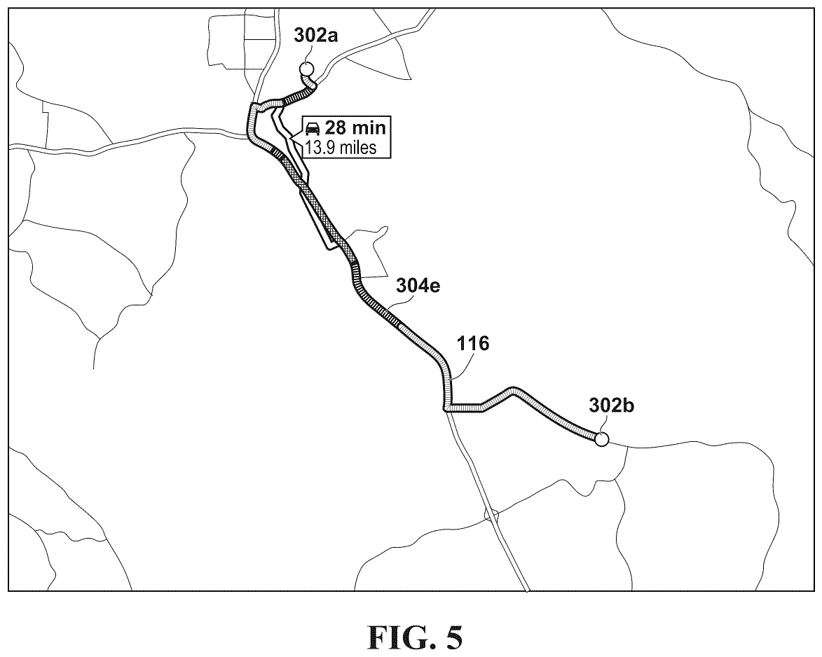

If the curve connecting the starting and ending locations 302a,b avoids the widened model of the road 400, another way in which to determine an expected travel route 304a-e is to determine that a navigation service route between the starting and ending locations 302a,b intersects the road 116. An example of this is shown in the map of FIG. 5. FIG. 5 shows the starting and ending locations 302a,b for a particular vehicle 102. While not shown in FIG. 5, a straight line connecting those starting and ending locations 302a,b avoids the widened model of the road 400, similar to the fourth expected travel route 302d described in respect of FIG. 4. In this situation, the mobile device 104 (or another suitable computing device, as noted above) may further use a navigation service such as Google Maps™ via an application programming interface (“API”) call, for example, to determine what route the service would have recommended to travel between the starting and ending locations 302a,b. A third party navigation service (e.g., Google Maps™, Apple Maps™, or an in-vehicle navigation system offered by the vehicle's 102 manufacturer) may be used in some embodiments; alternatively, a navigation service of similar functionality, run by the service provider controlling the first group of servers 106 or the authority controlling the second group of servers 108, may be used. This route, labeled as a fifth expected travel route 304e in FIG. 5, overlaps with at least a part of, and accordingly intersects, the road 116 of FIG. 5.

As using a service to determine a navigation service route in this fashion requires additional compute and cost, it may be used as a fallback or failsafe in the event the curve connecting the starting and ending locations 302a,b avoids the widened model of the road 400. Alternatively, using a service to determine the navigation service route in this manner may be done instead of, or always in addition to, determining whether the curve intersects the widened model of the road 400 for increased certainty in assessing travel routes.

For example, in at least some example embodiments, the navigation service may be used instead of generating the widened model of the road 400. In these embodiments, the mobile device 104 may submit the geographical coordinates of the starting and ending locations 302a,b into the navigation service, such as via an API call as described above. In response, the navigation service outputs a navigation service travel route such as the fifth expected travel route 304e in FIG. 5. The mobile device 104 concludes the navigation service travel route intersects with the road 116, and based on this determination concludes that the vehicle 102 did in fact travel along the road 116 when traveling between the starting and ending locations 302a,b, without generation of and/or reference to the widened model of the road 400.

While the above describes as an example the mobile device 104 performing functionality, such as determining whether the expected travel routes 304a-e intersect the widened version of the road 400, additionally or alternatively another suitable computing device, such as the first group of servers 106, may make this determination.

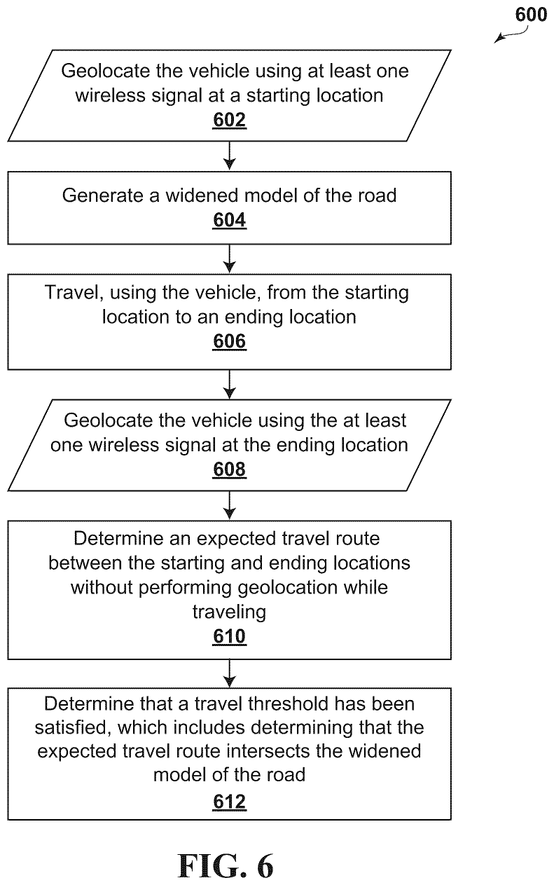

Referring now to FIG. 6, there is shown a flowchart depicting a method 600 for determining a vehicular travel route, according to an example embodiment. The method 600 is described below using the fourth expected travel route 304d as an example.

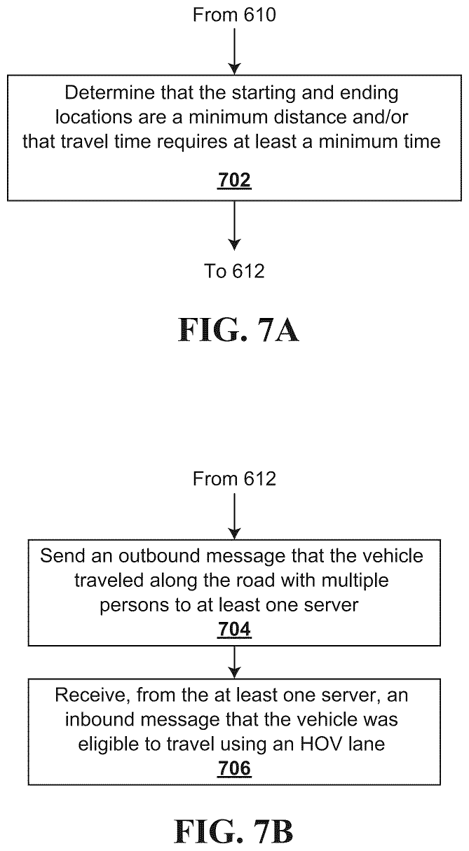

The method 600 beings at block 602 where the mobile device 102 geolocates the vehicle using at least one wireless signal, such as a GPS signal, at the starting location 302a. The mobile device 102 generates a widened model of the road at block 604 as described above, which in FIG. 4 comprises successively laying spaced circles 402 along a midline of the road 116. The vehicle 102, with the mobile device 104 therein, then travels from the starting location 302a to the ending location 302b at block 606. The mobile device 104 again performs geolocation at block 608 using the at least one wireless signal in order to obtain the position of the ending location 608. Following block 608, the mobile device 104 has geographical coordinates for both the starting and ending locations 302a,b, and accordingly is able to determine the expected travel route between the starting and ending locations 302a,b without performing geolocation while traveling. For the fourth expected travel route 302d, the mobile device 104 does this by connecting the starting and ending locations 302a,b with a straight line. Once block 610 is complete, the mobile device 104 determines that a travel threshold is satisfied, which includes determining that the expected travel route intersects the widened model of the road 612 as described above in respect of FIG. 4. For the fourth expected travel route 302d, this comprises determining that the line connecting the starting and ending locations 302a,b intersects a portion of the widened model of the road 400 that is outside the boundaries of the actual road 116. As described further below, such as in connection with FIG. 7A, the mobile device 104 may also take into consideration other factors, such as time and/or distance travel requirements, when determining whether the travel threshold is satisfied. The mobile device 104 accordingly determines that the vehicle 102 did travel along the road 116 while traveling from the starting location 302a to the ending location 302b without having access to geolocation services therebetween.

While block 604 is shown as occurring immediately after block 602 in FIG. 6, it need not be performed immediately after block 602 and may be performed at any time prior to block 612 in this example embodiment. Additionally and as noted above, while the mobile device 102 performs geolocation at blocks 602 and 608, and actually travels from the starting location 302a to the ending location 302b, the other operations of the method 600 may be performed by the mobile device 104 and/or another computing device, such as the first group of servers 106.

FIGS. 7A and 7B depict flowcharts of optional operations that may be performed during the method 600 for determining a vehicular travel route, according to example embodiments. FIG. 7A in particular describes operations that may also be performed to determine whether the travel threshold is satisfied. Block 702 of FIG. 7A involves, prior to determining that the expected travel route intersects the widened model of the road 400 at block 612, determining that the starting and ending locations 302a,bare at least one of a minimum distance or that travel time between the starting and ending locations 302a is at least a minimum travel time. An example minimum distance is 2 km along the expected travel route (which, for a straight line, is distance measured as the crow flies) and an example minimum travel time is 3 minutes, although other values for minimum distance and/or time may be suitable. Requiring minimum distance and/or travel times helps to reduce false positives by eliminating cases where use of an HOV/HOT lane is unlikely simply because of the short distances involved. While the minimum distance and time may be determined in respect of the entire length of the expected travel route as described above, alternatively they may be determined in respect only of that portion of the expected travel route that overlaps/intersects with the widened model of the road 400.

Similarly, when relying on the navigation service travel route, either in lieu of or in addition to determinations made in conjunction with the widened model of the road 400, in at least some embodiments the mobile device 104 may also determine whether the navigation service travel route overlaps with the road 116 for at least a minimum distance and/or that the travel time of the vehicle 104 along the portion of the navigation service travel route that overlaps with the road 116 is at least a minimum time. As noted above, examples value for these thresholds may be 2 km for distance and 3 minutes for time, with these values being determined based on the actual path traced by the navigation service travel route as opposed to a straight line or other curve connecting the starting and ending locations 302a,b. This addresses situations where the vehicle 102 may be driving over/under the road 116 via an overpass/underpass, for example.

Additional or alternative factors may be considered when determining that the travel threshold has been satisfied. For example, while in the above examples involving the widened model of the road 400 there is deemed to be an intersection between the expected travel routes 304a-e and the widened model of the road 400 if the expected travel routes 304a-e intersect even one of the circles 402, in alternative embodiments more than one of the circles 402 (or other shapes) may need to intersect the expected travel routes 304a-e in order for the travel threshold to be satisfied. This type of requirement eliminates incidental intersections that are not indicative of actual travel on the road 116.

As mentioned above, practically the method 600 for determining a vehicular travel route may be used when determining whether to permit the vehicle 102 to travel in an HOV/HOT lane. In at least some embodiments, determination may be done in conjunction with the first group of servers 106. More particularly, following determining that the vehicle 102 in fact traveled along the road 116 in cases where the road 116 comprises a high occupancy lane, which includes both HOV and HOT lanes, the mobile device 104 may at block 704 send an outbound message that the vehicle 102 traveled along the road with multiple persons therein to at least one server; and then at block 706 receive, from the at least one server, an inbound message that the vehicle 102 was eligible to perform the traveling using the high occupancy lane. The outbound message may be sent to the first group of servers 106, which makes the high occupancy lane eligibility determination and which can communicate that the vehicle 102 used the high occupancy lane to the second group of servers 108, which may be controlled by a transportation authority, as described above. Similarly, the acknowledgement that the mobile device 104 receives at block 706 may be from the first group of servers 106.

As noted above, the mobile device 104 and/or the first group of servers 106 may also determine that the requisite minimum plurality of riders are present in the vehicle 102 while traveling along the road 116. This may be done using biometric facial imaging by way of a camera on the mobile device 104, such as described in U.S. 2021/0174387. Biometric verification, and in particular biometric verification that relies on facial imagery, potentially raises privacy and related cybersecurity issues. Accordingly, in at least some embodiments, verification of the number of persons in the vehicle 102 while traveling along the road 116 may be done via a user interface, such as a graphical user interface (“GUI”) displayed on the mobile device 104 prompting a rider of the vehicle to manually input the number of riders in the vehicle 102. Upon arriving at the ending location 302b or upon the trip ending, for example, the mobile device 104 may then include in the outbound message the number of riders in the vehicle 102 as received via the GUI to facilitate the first and/or second group of servers 106, 108 determining whether the vehicle 102 was eligible to ride in a HOV/HOT lane. Additionally or alternatively, other types of interfaces (e.g., an audio interface in which a rider announces aloud how many riders are in the vehicle, or a visual interface in which the mobile device 104 uses its camera) may be possible.

In at least some embodiments, the ending location 302b and/or the end of the trip may actually be on or neighbor the road 116 itself. For example, a toll booth, rest area, checkpoint, or other stopping location may be on or neighbor the road, and the ending location 302b and/or the end of the trip may be deemed to be there. More particularly, a toll booth may be between the road's 116 main thoroughfare and an off-ramp leading off the road 116, or the toll booth may simply demarcate a tolled portion of the road 116 from a non-tolled portion of the road 116 (e.g., the toll booth may demarcate where the HOT lane ends). In this example, the ending location 302b may be deemed to be at or neighboring the road 116 itself, and the above described methods may be performed there to assess HOV/HOT lane eligibility. In an example in which the signal from the satellite 110 is lost due to an application on the mobile device 104 being suspended or terminated, having to interact with a toll booth may comprise manually re-activating or re-loading the application, thereby restoring the ability to receive and process navigation signals from the satellite 110. Additionally or alternatively, the toll booth or other stopping location may interact with the mobile device 104 (e.g., such as by having the mobile device 104 scan a QR code at the toll booth) that forces the mobile device 104 to treat the toll booth as the ending location 302b and that provides, or causes the mobile device 104 to load such as from a lookup table, the toll booth's geographical coordinates. Consequently, at the toll booth (or other stopping location), the mobile device 104 will deem that it is at the ending location 302b and will know the ending location's 302b location, thereby permitting it to perform the various embodiments herein. In particular, when the ending location 302b is on or neighboring the road 116, there may be particular benefit 1) to determining that the vehicle 102 has traveled the minimum distance and/or time thresholds as described above, and 2) to determining at the toll booth or other stopping location that the vehicle 102 is to be treated as having traveled in the HOV/HOT lane, as opposed to at the end of the actual trip or at a stopping location that is off the road 116.

Variations of the above described on-road verification embodiment are possible. For example:
(a) Instead of manually starting or selecting an application on the mobile device 104 to perform occupancy verification as described above, the stopping location may be geofenced such that the mobile device 104 automatically loads or runs the application for occupancy verification.
(b) Instead of relying on a rider in the vehicle 102 to manually input the number of riders via the mobile device's 104 GUI, an application on the mobile device 104, either manually or automatically, may use the mobile device's 104 camera to capture an image of all riders to verification purposes. The image may then be analyzed as described in U.S. 2021/0174387.
(c) The image or a variation thereof (e.g., an image with all riders'faces blurred for security purposes) may be included in the outbound message to the first group of servers 106.
(d) In the event some form of payment is required to use an HOT lane (e.g., a partial payment of an undiscounted price for a vehicle with a single rider, with the partial payment optionally reducing with an increasing number of riders), payment may be made via a transponder device in the vehicle 102 or a separate payment system (e.g., based on license plate recognition or a Bluetooth™/Near Field Communication signal).

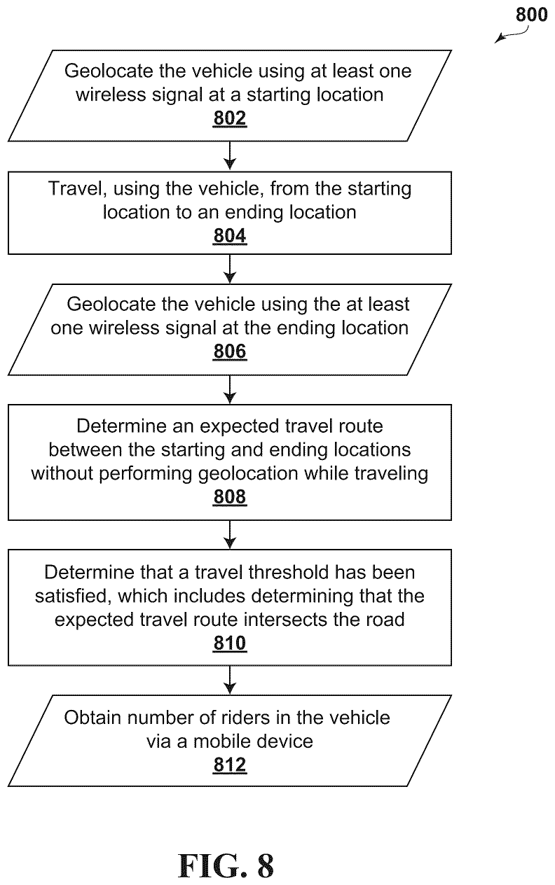

FIG. 8 is a flowchart depicting a method 800 for determining a vehicular travel route, according to an example embodiment. The method 800 is applicable even in embodiments in which the widened model of the road 400 is not generated. Blocks 802, 804, 806, and 808 are analogous to blocks 602, 606, 608, and 610, respectively, of the method 600 of FIG. 6.

At block 810, the method 800 comprises determining that a travel threshold has been satisfied, where making this determination comprises determining that the expected travel route intersects the road 116. This contrasts with block 612 in that it excludes a requirement to generate and rely on the widened model of the road 400, as an embodiment in which the expected travel route is a navigation service route corresponding to a route generated by a navigation service overlaps with the road 116 and accordingly recourse to the widened model of the road 400 is unnecessary. As mentioned above, the travel threshold may also require that minimum distance and/or time thresholds as determined in respect of the portion of the expected travel route that overlaps with the road 116 be additionally applied before concluding that the vehicle 102 did, in fact, travel along the road 116 between the starting and ending locations 302a, b.

Block 812, which is optional in some embodiments, involves obtaining a number of riders in the vehicle 102 via the mobile device 104. As described above, this can be done by prompting a rider via a GUI on the mobile device 104 to enter the number of riders, or using another interface (e.g., audio, camera-based) to determine the number of riders. As described above in respect of FIG. 7B, this ridership information may be transmitted to the first group of servers 106 as part of the outbound message to permit the first group of servers 106 to determine whether the vehicle 102 was eligible to travel in an HOV/HOT lane.

The embodiments have been described above with reference to flow, sequence, and block diagrams of methods, apparatuses, systems, and computer program products. In this regard, the depicted flow, sequence, and block diagrams illustrate the architecture, functionality, and operation of implementations of various embodiments. For instance, each block of the flow and block diagrams and operation in the sequence diagrams may represent a module, segment, or portion of code, which comprises one or more executable instructions for implementing the specified action(s). In some alternative embodiments, the action(s) noted in that block or operation may occur out of the order noted in those figures. For example, two blocks or operations shown in succession may, in some embodiments, be executed substantially concurrently, or the blocks or operations may sometimes be executed in the reverse order, depending upon the functionality involved. Some specific examples of the foregoing have been noted above but those noted examples are not necessarily the only examples. Each block of the flow and block diagrams and operation of the sequence diagrams, and combinations of those blocks and operations, may be implemented by special purpose hardware-based systems that perform the specified functions or acts, or combinations of special purpose hardware and computer instructions.

The terminology used herein is for the purpose of describing particular embodiments only and is not intended to be limiting. Accordingly, as used herein, the singular forms “a”, “an”, and “the” are intended to include the plural forms as well, unless the context clearly indicates otherwise. It will be further understood that the terms “comprises” and “comprising”, when used in this specification, specify the presence of one or more stated features, integers, steps, operations, elements, and components, but do not preclude the presence or addition of one or more other features, integers, steps, operations, elements, components, and groups. Directional terms such as “top”, “bottom”, “upwards”, “downwards”, “vertically”, and “laterally” are used in the following description for the purpose of providing relative reference only, and are not intended to suggest any limitations on how any article is to be positioned during use, or to be mounted in an assembly or relative to an environment. Additionally, the term “connect” and variants of it such as “connected”, “connects”, and “connecting” as used in this description are intended to include indirect and direct connections unless otherwise indicated. For example, if a first device is connected to a second device, that coupling may be through a direct connection or through an indirect connection via other devices and connections. Similarly, if the first device is communicatively connected to the second device, communication may be through a direct connection or through an indirect connection via other devices and connections.

Use of language such as “at least one of X, Y, and Z,” “at least one of X, Y, or Z,” “at least one or more of X, Y, and Z,” “at least one or more of X, Y, and/or Z,” or “at least one of X, Y, and/or Z,” is intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

It is contemplated that any part of any aspect or embodiment discussed in this specification can be implemented or combined with any part of any other aspect or embodiment discussed in this specification, so long as such those parts are not mutually exclusive with each other.

The scope of the claims should not be limited by the embodiments set forth in the above examples, but should be given the broadest interpretation consistent with the description as a whole.

It should be recognized that features and aspects of the various examples provided above can be combined into further examples that also fall within the scope of the present disclosure. In addition, the figures are not to scale and may have size and shape exaggerated for illustrative purposes.

1. A method for determining that a vehicle has traveled along a road, the method comprising:
(a) geolocating the vehicle using at least one wireless signal at a starting location;
(b) after traveling, using the vehicle, from the starting location to an ending location:
(i) geolocating the vehicle using the at least one wireless signal at the ending location; and
(ii) determining that, during the traveling, the vehicle traveled along the road by:
(A) determining an expected travel route of the vehicle between the starting location and the ending location without using the at least one wireless signal to perform geolocation while traveling from the starting location to the ending location; and
(B) determining that a travel threshold has been satisfied, wherein satisfying the travel threshold comprises determining the expected travel route intersects the road or a widened model of the road.

2. The method of claim 1, further comprising generating the widened model of the road, wherein:
(a) the widened model of the road is wider along at least a portion thereof than a corresponding portion of the road; and
(b) satisfying the travel threshold comprises determining the expected travel route intersects the widened model of the road.

3. The method of claim 1, wherein:
(a) determining the expected travel route of the vehicle comprises obtaining a navigation service route between the starting and ending locations from a navigation service; and
(b) satisfying the travel threshold comprises determining the expected travel route intersects the road.

4. The method of claim 1, wherein the ending location corresponds to a location on the road.

5. The method of claim 4, wherein the ending location corresponds to a toll booth on the road.

6. The method of claim 1, further comprising:
(a) displaying, on a graphical user interface, a prompt requesting entry of a number of riders in the vehicle; and
(b) determining a number of riders in the vehicle based on a response to the prompt.

7. The method of claim 2, wherein generating the widened model of the road comprises positioning a plurality of shapes intermittently along a route corresponding to at least a portion of the road, wherein each of the plurality of identical shapes extends beyond sides of the route.

8. The method of claim 7, wherein the shapes are identical to each other.

9. The method of claim 7, wherein the shapes are circles centered along a midline of the route.

10. The method of claim 7, wherein successive ones of the shapes overlap with each other.

11. The method of claim 7, wherein the travel threshold comprises the expected travel route intersecting at least two of the shapes.

12. The method of claim 2, wherein determining that the expected travel route intersects the widened model of the road comprises determining that a curve connecting the starting and ending locations intersects the widened model of the road, wherein the portion of the widened model of the road that is intersected corresponds to an area outside the sides of the road.

13. The method of claim 12, wherein only one of the starting and ending locations is located in the area outside the sides of the road and within the widened model of the road.

14. The method of claim 12, wherein both of the starting and ending locations are located in the area outside the sides of the road and within the widened model of the road, and are also on a same one of the sides of the road.

15. The method of claim 2, wherein determining that the expected travel route intersects the widened model of the road comprises:
(a) determining that a linear connection between the starting and ending locations avoids the widened model of the road;
(b) obtaining a navigation service route between the starting and ending locations from a navigation service;
(c) determining that the navigation service route between the starting and ending locations intersects the road.

16. The method of claim 1, wherein determining the travel threshold is satisfied further comprises, after the traveling, determining that a portion of the expected travel route that overlaps with the road is at least one of a minimum distance long or that traveling between the starting and ending locations along the expected travel route requires at least a minimum time.

17. The method of claim 1, wherein the vehicle is traveling from the starting location to the ending location as part of a trip taken by the vehicle, and wherein at least one of:
(a) the starting location differs from a location corresponding to a beginning of the trip; or
(b) the ending location differs from an end of the trip.

18. The method of claim 1, wherein the road comprises a high occupancy lane, and wherein the method further comprises:
(a) sending an outbound message that the vehicle traveled along the road with multiple persons therein to at least one server; and
(b) receiving, from the at least one server, an inbound message that the vehicle was eligible to perform the traveling using the high occupancy lane,
wherein the ending location corresponds to a location on or neighboring the road, and
wherein the outbound message is sent while the vehicle is at the ending location.

19. A system for determining that a vehicle has traveled along a road, the system comprising:
(a) an antenna for receiving at least one wireless signal;
(b) a processing unit, communicatively coupled to the antenna, and configured to:
(i) geolocate the vehicle using at least one wireless signal at a starting location;
(ii) after traveling, using the vehicle, from the starting location to an ending location:
(A) geolocate the vehicle using the at least one wireless signal at the ending location; and
(B) determine that, during the traveling, the vehicle traveled along the road by:
(1) determining an expected travel route of the vehicle between the starting location and the ending location without using the at least one wireless signal to perform geolocation while traveling from the starting location to the ending location; and
(2) determining that a travel threshold has been satisfied, wherein satisfying the travel threshold comprises determining the expected travel route intersects the road or a widened model of the road.

20. At least one non-transitory computer readable medium having stored thereon computer program code that is executable by at least one processor and that, when executed by the at least one processor, causes the at least one processor to perform a method for determining that a vehicle has traveled along a road, the method comprising:
(a) geolocating the vehicle using at least one wireless signal at a starting location;
(b) after traveling, using the vehicle, from the starting location to an ending location:
(i) geolocating the vehicle using the at least one wireless signal at the ending location; and
(ii) determining that, during the traveling, the vehicle traveled along the road by:
(A) determining an expected travel route of the vehicle between the starting location and the ending location without using the at least one wireless signal to perform geolocation while traveling from the starting location to the ending location; and
(B) determining that a travel threshold has been satisfied, wherein satisfying the travel threshold comprises determining the expected travel route intersects the road or a widened model of the road.
